(19) United States
(12) Patent Application Publication
(10) Pub. No.: US 2026/0048331 A1
(43) Pub. Date: Feb. 19, 2026

(54) METHODS AND SYSTEMS FOR FANTASY SPORTS TEAM PROCUREMENT

(71) Applicant: CapTrade Sports LLC, Leesburg, VA (US)

(72) Inventor: Joseph Powell Chapin, Kensington, MD (US)

(21) Appl. No.: 19/301,312

(22) Filed: Aug. 15, 2025

Related U.S. Application Data
(60) Provisional application No. 63/683,416, filed on Aug. 15, 2024.

(51) Int. Cl. A63F 13/828

(52) U.S. Cl. CPC A63F 13/828

(57) ABSTRACT

A system for procuring fantasy sports teams for one or more users competing in a fantasy sports league includes a sports information server and a management server in communication with the sports information server via a network. The management server includes a roster procurement engine; one or more processors; and one or more memories, where the one or more memories store instructions thereon that, when executed by the one or more processors, cause the system to: receive team unit data from the sports information server, provide a set of team units, receive a fantasy sports roster for each of the one or more users, receive one or more steal request notifications from the one or more user devices targeting a specific team unit, and reassign one or more of the team units as a result of the one or more steal request notifications.

### CROSS-REFERENCE TO RELATED APPLICATIONS

This application claims priority to U.S. Provisional Patent Application No. 63/683,416, filed Aug. 15, 2024 and entitled “METHODS AND SYSTEMS FOR FANTASY SPORTS TEAM PROCUREMENT,” the entire disclosure of which is incorporated herein by reference for all purposes.

### BACKGROUND

Fantasy sports are a very popular digital activity that provides sports fans an alternative way to interact with sports leagues and teams. Generally, a fantasy league is set up to provide head-to-head competition between participants in fantasy sports. The league includes a certain number of participants who each choose either players or portions of sports teams (typically via a fantasy draft). Once the players/portions of sports teams are chosen, each participant in the league will face off against another participant in the league, where winners are determined as a result of a participant accumulating more fantasy points than their opponents.

Typically, a fantasy sports league in which participants draft single players (as opposed to portions of a team) embodies specific characteristics and functionalities that can disrupt the gameplay experience. For example, player injuries that occur during a sports season can easily derail a participant's season, especially if the player that is injured has the potential to score a significant amount of fantasy points for a team. This instance would essentially ruin the fantasy sports experience for the participant for that season. Another issue for fantasy sports leagues with single player drafts involves transactions during a given season. Transactions made during a season (such as waiver wire additions and trades) often take a great deal of time and, in the case of trades, rarely end up occurring. Waiver wire additions are also normally negligibly impactful to a manager's success.

An additional issue that single player draft fantasy sports leagues face is the creation of the misalignment of incentives of the participants when compared with a normal sports fan. While a sports fan will want their team to score points or stop the opposing team from scoring, a fantasy sports participant will root for very specific events to occur in a sporting event. For example, a fantasy sports participant may need a particular player to score a rushing touchdown for a football team in a football game but not a receiving touchdown because the participant's opponent has the referenced team's quarterback. This can lead to additional stress and overall reduced enjoyment of the fantasy sports experience for the fantasy sports participant.

While fantasy sports are popular throughout the world, gameplay experience issues are prevalent in systems running the fantasy sports, leading to room for improvement and a need for an enhanced gameplay experience of said systems.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of an exemplary environment including components associated with managing fantasy sports teams, in accordance with certain embodiments of the present disclosure;

FIG. 2 is an illustration of a computing machine and a system applications module, in accordance with certain example embodiments;

FIGS. 3A-3H are illustrations of example screenshots of a user interface on a user device, in accordance with certain embodiments of the present disclosure; and

FIG. 4 is an illustration of a flow diagram of an exemplary method for procuring fantasy sports teams for one or more users competing in a fantasy sports league, in accordance with certain example embodiments.

The illustrated figures are only exemplary and are not intended to assert or imply any limitation with regard to the environment, architecture, design, or process in which different examples may be implemented.

### DETAILED DESCRIPTION

The present invention relates generally to computerized methods and systems for fantasy sports team procurement and management, and more particularly to the procurement of fantasy sports teams by team managers of a fantasy sports league.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Unless otherwise indicated, all numbers expressing quantities of components and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Presented herein is a system for procuring fantasy sports teams for one or more users competing in a fantasy sports league. The system comprises a sports information server and a management server in communication with the sports information server via a network. The management server includes a roster procurement engine, one or more processors, and one or more memories, where the one or more memories store instructions thereon that, when executed by the one or more processors, cause the system to: receive team unit data from the sports information server, where the team unit data includes team unit performance statistics collected from one or more past real life sporting events. A set of team units are then provided, where the set of team units is configured to be accessible by one or more user devices. A fantasy sports roster is then received for each of the one or more users, where each of the fantasy sports rosters comprise one or more team units configured to participate in one or more future real life sporting events. One or more steal request notifications are received from the one or more user devices, where each of the one or more steal request notifications target a specific team unit. As a result of the one or more steal request notifications, one or more of the team units are reassigned.

Also presented herein is a method for procuring fantasy sports teams for one or more users competing in a fantasy sports league. The method comprises providing a fantasy sports management server in communication with a sports information server via a network. Fantasy sports management server receives team unit data from sports information server, where the team unit data includes team unit performance statistics collected from one or more past real life sporting events. Once the team unit data is received, fantasy sports management server provides a set of team units, where the set of team units is configured to be accessible by one or more team manager user devices. The fantasy sports management server receives a fantasy sports roster for each of the one or more team managers, where each of the fantasy sports rosters comprise one or more team units configured to participate in one or more future real life sporting events. Fantasy sports management server receives one or more steal request notifications from the one or more team manager user devices, where each of the one or more steal request notifications target a specific team unit. Roster procurement engine reassigns one or more of the team units as a result of the one or more steal request notifications.

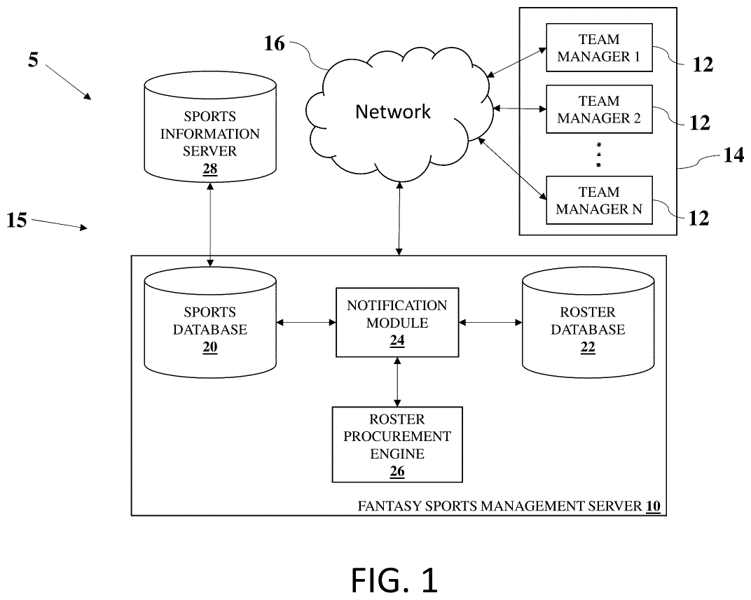

FIG. 1 is an illustration of an exemplary environment 5 including components associated with a fantasy sports management system 15 for procuring and managing fantasy sports teams for fantasy sports leagues, in accordance with certain embodiments of the present disclosure. As shown in FIG. 1, system 15 may include computing devices 12 associated with N respective team managers 12 of a fantasy sports league 14 (e.g., four team managers 12, ten team managers 12, etc.). Each of the computing devices 12 may include any suitable type of computing device having wired and/or wireless communication capabilities, such as a personal computer, tablet, phablet, smartphone, etc. Each of the team manager computing devices 12 may be communicatively coupled to fantasy sports management server 10 via one or more electronic or communications networks 16. The one or more electronic or communications networks 16 may be a single network, or may include multiple networks of one or more types (e.g., one or more wired and/or wireless LANs, and/or one or more wired and/or wireless WANs such as the Internet), for example. Each of the team managers 12 may be an individual associated with a fantasy sports league 14 in which the team managers 12 are in competition with one another to score the most points during a specific period of time (weekly, seasonally, etc.) using fantasy sports teams obtained during a draft or another type of allocation mechanism. In one non-limiting embodiment, the fantasy sports teams may include offensive teams, defensive teams, and special teams associated with a professional football league.

Environment 5 may include fantasy sports management server 10, which may comprise a computing system. Fantasy sports management server 10 may include one or more servers, or may include a plurality of networked computing devices that have an appearance of a single, logical computing device or system, e.g., a peer group of computing devices, a group of cloud computing devices, or the like. Fantasy sports management server 10 may be communicatively coupled to computing devices 12 via one or more electronic or communications networks 16. The one or more electronic or communications networks 16 may be a single network, or may include multiple networks of one or more types (e.g., one or more wireless and/or wired local area networks (LANs), and/or one or more wireless and/or wired wide area networks (WANs) such as the Internet), for example.

Fantasy sports management server 10 may include various components, including a sports database 20, a roster database 22, a notification module 24, and/or a roster procurement engine 26. Each of some or all of the components 20, 22, 24, and 26 may be (or may include) a respective set of one or more computing devices or processors that executes software or computer-executable instructions to perform the corresponding functions described herein. Alternatively, each of some or all of the components 20, 22, 24, and 26 may be, or include, a respective component of software or set of computer-executable instructions that is stored on one or more tangible, non-transitory computer-readable media (e.g., a random access memory (RAM) and/or read-only memory (ROM) of the fantasy sports management server 10) and that is executed by one or more processors of the fantasy sports management server 10 to perform the corresponding functions described herein. Still additionally or alternatively, each of some or all of the components 20, 22, 24, and 26 may at least partially comprise hardware and/or firmware. Further, one or more of the components 20, 22, 24, and 26 may be combined into a single unit, or may be omitted.

In an embodiment, a system 15 for procuring fantasy sports teams for one or more users competing in a fantasy sports league is provided. The system includes a sports information server 28 and a management server (fantasy sports management server 10) in communication with the sports information server 28 via a network 16. Management server 10 includes a roster procurement engine 26, one or more processors, and one or more memories, where the one or more memories store instructions thereon that, when executed by the one or more processors, cause the system 15 to: receive team unit data from the sports information server 28, where the team unit data includes team unit performance statistics collected from one or more past real life sporting events. The instructions further include providing a set of team units, where the set of team units is configured to be accessible by one or more user devices. The instructions further include receiving a fantasy sports roster for each of the one or more users, where each of the fantasy sports rosters comprise one or more team units configured to participate in one or more future real life sporting events. The instructions further include receiving one or more steal request notifications from the one or more user devices, where each of the one or more steal request notifications target a specific team unit. The instructions further include reassigning one or more of the team units as a result of the one or more steal request notifications.

In an embodiment, the fantasy sports league is a fantasy football fantasy sports league. In an additional, embodiment, each of the set of team units comprise one of: a team offensive unit, a team defensive unit, or a team special teams unit.

In an embodiment, the instructions, when executed by the one or more processors, further cause the system 15 to: assign a virtual valuation to at least some of the team units as a result of a draft performed by the one or more users. In an additional embodiment, the draft is an auction draft performed by the one or more users.

In an embodiment, the instructions, when executed by the one or more processors, further cause the system 15 to: send the one or more steal request notifications to respective user devices of the one or more user devices, where each of the one or more steal request notifications include a request to perform at least one of: sell one of the one or more team units at a first bid amount, block a steal attempt by matching a bid of a respective user of the one or more users that sent a respective one of the one or more steal request notifications, and elect to filibuster. In an additional embodiment, as a result of the electing of the filibuster, the instructions, when executed by the one or more processors, further cause the system 15 to reassign the one or more of the team units after a window of time has passed from an initial sending of a respective one of the one or more steal request notifications. In an additional embodiment, as a result of the electing of the filibuster, the instructions, when executed by the one or more processors, further cause the system 15 to: reassign the one or more of the team units as a result of a respective one of the one or more users sending a second bid amount to a respective one of the one or more user devices, where the second bid amount is greater than the first bid amount.

In one embodiment, the sports database 20 may receive and store real-time information related to actual sports teams and/or players. The sports team/player information may be received and stored at sports database 20 from a sports information server 28 provided by one or more sports leagues, sports teams, and/or sports analytics companies. Sports database 20 may include any suitable type of persistent memory, and may comprise one or more data storage devices that have the appearance of a single, logical data storage device. Additionally or alternatively, the sports database 20 may be triggered to update a sports team profile stored in roster database 22. For example, the act of initially storing updated parameters/metrics of a sports team may trigger the sports database 20 to generate an updated sports team profile that may be sent to roster database 22 to replace an outdated sports team profile (associated with one or more team managers 12). Additionally or alternatively, sports database 20 may regularly scan sports information server 28 for newly added parameters/metrics of sports teams and/or generate updated sports team profiles therefrom, and/or sports database 20 may scan sports information server 28 for newly added parameters/metrics when directed to by a user or by another system. In additional embodiments, sports database 20 and roster database 22 may be a single database.

In examples described herein, a fantasy sports management server 10 allows team managers 12 to participate in the procurement of one or more fantasy sports teams associated with one or more of the team managers 12 in a league 14. In certain embodiments, through the use of the fantasy sports management server 10, team managers 12 can place a bid on one or more team units using a digital currency specific to the fantasy sports management server 10. As a result of this auction-style draft, market values for each offensive team and each defensive team are established. Once each team manager 12 is assigned an appropriate amount of team units (for example, in relation to a fantasy football league, each team manager may be assigned a team offense and a team defense) as a result of the draft, notification module 24 may receive one or more steal request notifications from one or more team managers 12. Each steal request notification is redirected to the team manager 12 that owns a team unit identified in the steal request notification. Notification module 24 then receives a reply notification from a team manager 12 to a steal request notification. The reply notification includes an action to be performed by roster procurement engine 26.

In response to each reply notification, roster procurement engine 26 may perform at least one of: transfer the team unit that is the subject of each steal request notification to each team manager 12 that sent each steal request notification and subsequently transferring digital currency matching a bid correlated to each steal request notification to each team manager 12 who owned a transferred team unit, receive a digital currency payment matching a bid correlated to each steal request notification from the team managers 12 that received a steal request notification, and/or transfer the team unit that is the subject of each steal request notification to each team manager 12 that sent each steal request notification after a twenty four hour window of time occurs from the sending of the steal request notification. It is noted that in embodiments, the three aforementioned actions capable of being performed by roster procurement engine 26 may correlate with three sets of instructions that a team manager 12 can choose from and are presented within each steal request notification. The correlating instructions include: selling a team unit in response to receiving a steal request notification, blocking a steal request by matching a bid correlated to each steal request notification, and “filibustering”, or selling a team unit in response to receiving a steal request notification after a delay period (twenty four hour window after a steal request notification is sent). In regard to “filibustering”, if this action is chosen, a manager who received the steal request notification may counter the other team manager's bid and request a higher bid for the team unit that is attempting to be stolen. If the higher bid is not matched within a certain time period (e.g., 24 hours), then a transfer of the team is carried out after the time period has elapsed at the original bid price (with the team manager 12 who received the steal request notification receiving the original bid price and the team manager 12 who sent the steal request notification receiving the team unit that is the subject of the steal request notification). If the higher bid is matched within the time period, the team unit and the matched bid are sent to the appropriate team managers 12. It is noted that as a result of the configuration of fantasy sports management server 10, an implementation of a fantasy sports system that blends an analytical focus of a daily fantasy sports system with a season-long competitive format of a traditional fantasy sports system may be implemented. Additionally, by virtue of the steal request notification and its resulting actions/implications, gameplay dynamics are more interactive and enhanced.

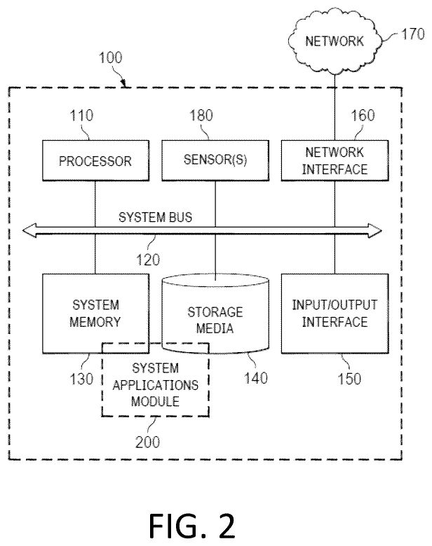

Referring now to FIG. 2, illustrated is a computing machine 100 and a system applications module 200, in accordance with example embodiments. The computing machine 100 can correspond to any of the various computers, mobile devices, laptop computers, Internet of Things (IoT), servers, embedded systems, or computing systems presented herein. The module 200 can comprise one or more hardware or software elements, e.g. other OS application and user and kernel space applications, designed to facilitate the computing machine 100 in performing the various methods and processing functions presented herein. The computing machine 100 can include various internal or attached components such as a processor 110, system bus 120, system memory 130, storage media 140, input/output interface 150, a network interface 160 for communicating with a network 170, e.g. cellular/GPS, Bluetooth, WIFI, or Devicenet, EtherCAT, Analog, RS485, etc., and one or more sensors 180.

The computing machines can be implemented as a conventional computer system, an embedded controller, a laptop, a server, a mobile device, a smartphone, a wearable computer, a customized machine, any other hardware platform, or any combination or multiplicity thereof. The computing machines can be a distributed system configured to function using multiple computing machines interconnected via a data network or bus system.

Processor 110 can be designed to execute code instructions in order to perform the operations and functionality described herein, manage request flow and address mappings, and to perform calculations and generate commands. Processor 110 can be configured to monitor and control the operation of the components in the computing machines. Processor 110 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. Processor 110 can be a single processing unit, multiple processing units, a single processing core, multiple processing cores, special purpose processing cores, co-processors, or any combination thereof. According to certain embodiments, processor 110 along with other components of computing machine 500 can be a software based or hardware based virtualized computing machine executing within one or more other computing machines.

The system memory 130 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 130 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 130. The system memory 130 can be implemented using a single memory module or multiple memory modules. While the system memory 130 is depicted as being part of the computing machine, one skilled in the art will recognize that the system memory 130 can be separate from the computing machine 500 without departing from the scope of the subject technology. It should also be appreciated that the system memory 130 can include, or operate in conjunction with, a non-volatile storage device such as the storage media 140.

The storage media 140 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 140 can store one or more operating systems, application programs and program modules, data, or any other information. The storage media 140 can be part of, or connected to, the computing machine. The storage media 140 can also be part of one or more other computing machines that are in communication with the computing machine such as servers, database servers, cloud storage, network attached storage, and so forth.

The applications module 200 and other OS application modules can comprise one or more hardware or software elements configured to facilitate the computing machine with performing the various methods and processing functions presented herein. The applications module 600 and other OS application modules can include one or more algorithms or sequences of instructions stored as software or firmware in association with the system memory 130, the storage media 140 or both. The storage media 140 can therefore represent examples of machine or computer readable media on which instructions or code can be stored for execution by the processor 110. Machine or computer readable media can generally refer to any medium or media used to provide instructions to the processor 110. Such machine or computer readable media associated with the applications module 200 and other OS application modules can comprise a computer software product. It should be appreciated that a computer software product comprising the applications module 200 and other OS application modules can also be associated with one or more processes or methods for delivering the applications module 200 and other OS application modules to the computing machine via a network, any signal-bearing medium, or any other communication or delivery technology. The applications module 200 and other OS application modules can also comprise hardware circuits or information for configuring hardware circuits such as microcode or configuration information for an FPGA or other PLD. In one exemplary embodiment, applications module 200 and other OS application modules can include algorithms capable of performing the functional operations described by the flow charts (modes of operation) computer systems presented herein.

The input/output (“I/O”) interface 150 can be configured to couple to one or more external devices, to receive data from the one or more external devices, and to send data to the one or more external devices. Such external devices along with the various internal devices can also be known as peripheral devices. The I/O interface 150 can include both electrical and physical connections for coupling the various peripheral devices to the computing machine or the processor 110. The I/O interface 150 can be configured to communicate data, addresses, and control signals between the peripheral devices, the computing machine, or the processor 110. The I/O interface 150 can be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 150 can be configured to implement only one interface or bus technology. Alternatively, the I/O interface 150 can be configured to implement multiple interfaces or bus technologies. The I/O interface 150 can be configured as part of, all of, or to operate in conjunction with, the system bus 120. The I/O interface 150 can include one or more buffers for buffering transmissions between one or more external devices, internal devices, the computing machine, or the processor 110.

The I/O interface 150 can couple the computing machine to various input devices including mice, touch-screens, scanners, electronic digitizers, sensors, receivers, touchpads, trackballs, cameras, microphones, keyboards, any other pointing devices, or any combinations thereof. The I/O interface 150 can couple the computing machine to various output devices including video displays, speakers, printers, projectors, tactile feedback devices, automation control, robotic components, actuators, motors, fans, solenoids, valves, pumps, transmitters, signal emitters, lights, and so forth.

The computing machine 100 can operate in a networked environment using logical connections through the NIC 160 to one or more other systems or computing machines across a network. The network 170 can include wide area networks (WAN), local area networks (LAN), intranets, the Internet, wireless access networks, wired networks, mobile networks, telephone networks, optical networks, or combinations thereof. The network 170 can be packet switched, circuit switched, of any topology, and can use any communication protocol. Communication links within the network 170 can involve various digital or an analog communication media such as fiber optic cables, free-space optics, waveguides, electrical conductors, wireless links, antennas, radio-frequency communications, and so forth. The sensors 180 can be traditional sensors or semiconductor based sensors.

The processor 110 can be connected to the other elements of the computing machine or the various peripherals discussed herein through the system bus 120. It should be appreciated that the system bus 120 can be within the processor 110, outside the processor 110, or both. According to some embodiments, any of the processors 110, the other elements of the computing machine, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

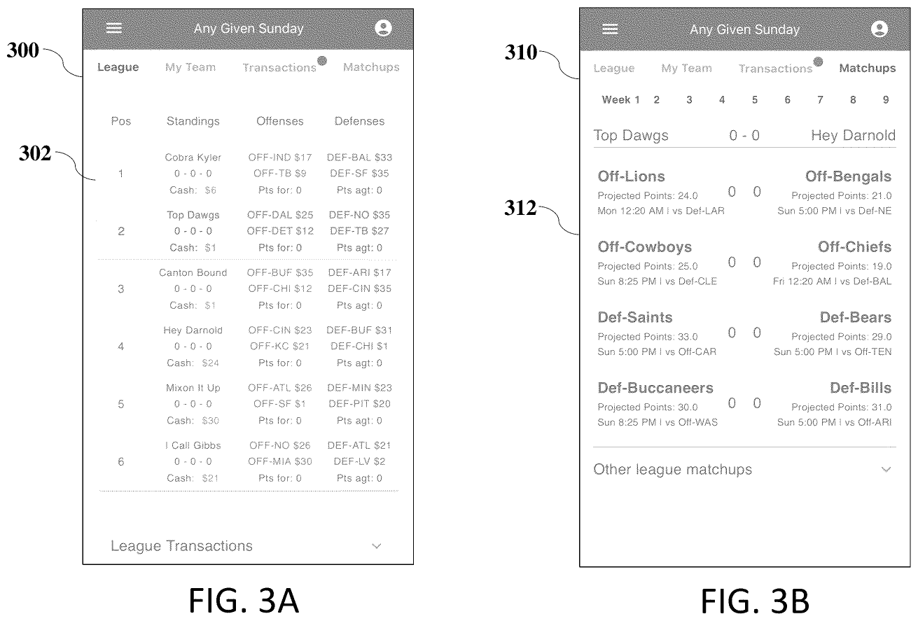

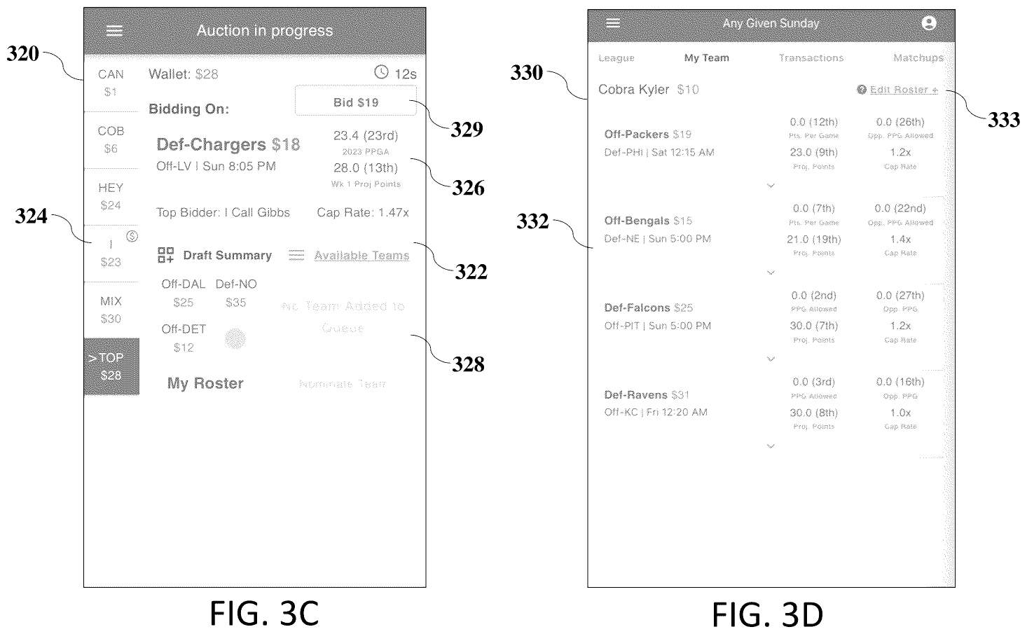

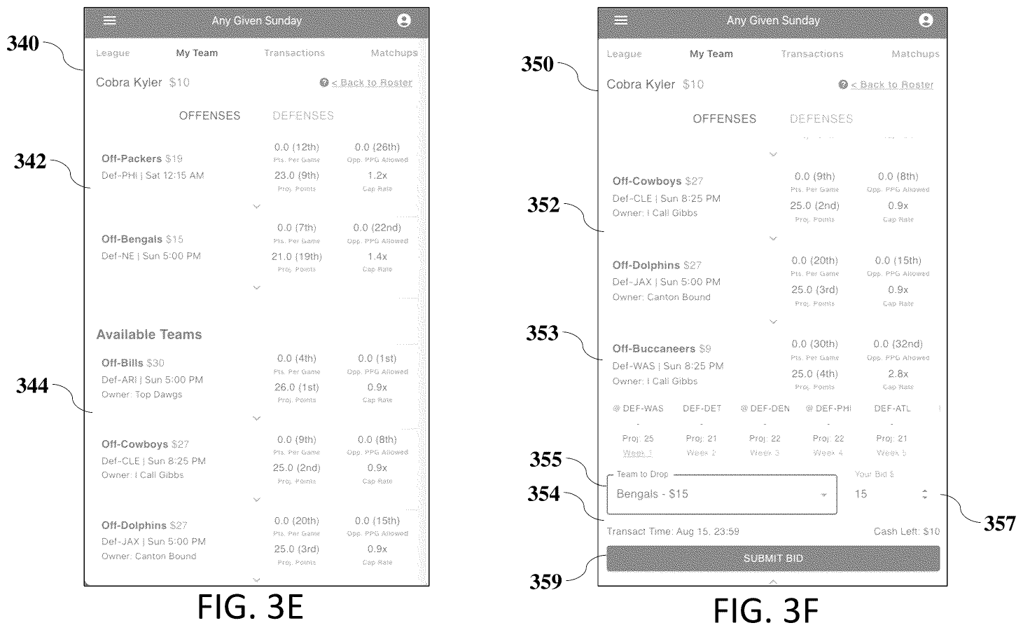

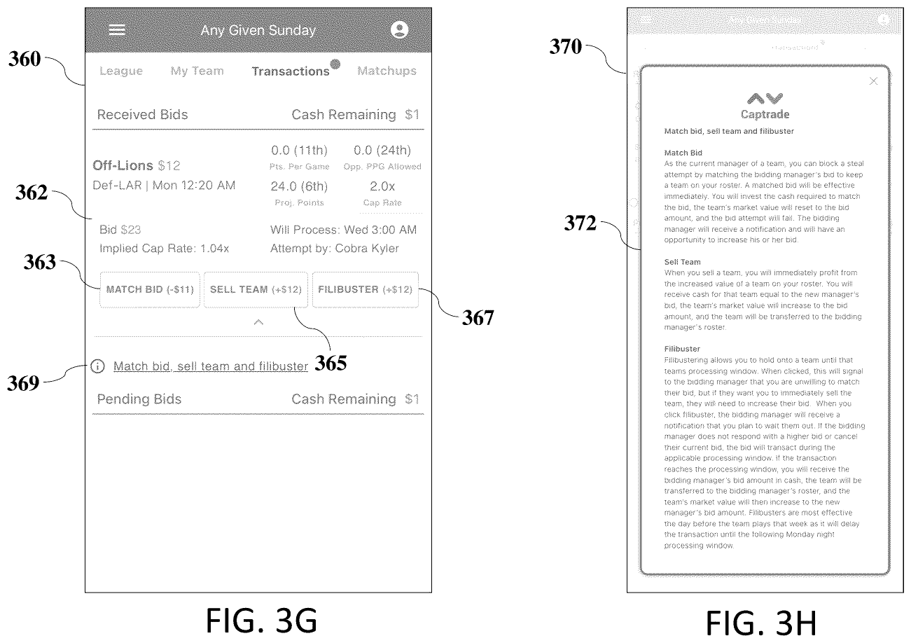

FIGS. 3A-3H are illustrations of example screenshots of a user interface 300, 310, 320, 330, 340, 350, 360, 370 on a user device, in accordance with certain embodiments of the present disclosure. In the description below of FIGS. 3A-3H, reference may be made to reference characters representing like features as shown and described with respect to FIG. 1. It is noted that the illustrations of FIGS. 3A-3H may depict screenshots presenting different pages of a fantasy football league user application.

FIG. 3A illustrates an example screenshot of a user interface 300 for providing league 14 summary information. User interface 300 includes a live report section 302 (located under a “League” tab) illustrating a current live update of team manager 12 profiles and their rankings. As shown, each team manager 12 is ranked from one to six. Each profile includes the current amount of digital currency of each team manager 12, as well as the current roster of each team manager 12 that includes a team offense and a team defense and each team's current market value.

FIG. 3B illustrates an example screenshot of a user interface 310 informing a team manager 12 of matchup information generated by sports management server 10. User interface 310 includes a matchup section 312 (located under a “Matchups” tab) that informs the team manager 12 of the other team manager 12 that they are facing off against in a given week. More specifically, matchup section 312 shows matchups between team units (two team offenses and two team defenses) of two competing team managers 12. As shown, the roster of the “Top Dawgs” team manager 12 (which includes the Lions team offense, the Cowboys team offense, the Saints team defense, and the Buccaneers team defense) faces off against the roster of the “Hey Darnold” team manager 12 (which includes the Bengals team offense, the Chiefs team offense, the Bears team defense, and the Bills team defense). Additionally, projected points and matchup information is shown below each team unit, which presents an amount of points each team unit is expected to score in a given week against the team unit that they are scheduled to play against (also shown below each team unit).

FIG. 3C illustrates an example screenshot of a user interface 320 informing a team manager 12 of auction draft information generated by sports management server 10. As shown user interface 320 presents a draft auction being carried out with six team managers 12. User interface 320 includes an auction draft section 322 generated by roster procurement engine 26 that informs the team manager 12 of details relating to a fantasy draft of the league 14 that team manager 12 is associated with. As shown, auction section 322 includes a draft order section 324 indicating the order and the team manager that chose the current team unit being bid on (highlighted), a current team section 326 indicating the current team unit being bid on, a draft summary section 328 indicating the team units already chosen in the fantasy draft by the team manager 12 as well as the teams chosen by a specific team manager 12, and a bid icon 329 presenting a user-engageable icon that, when engaged, will submit a bid amount for the current team unit.

FIG. 3D illustrates an example screenshot of a user interface 330 informing a team manager 12 of the team manager's 12 roster/team units (as shown, two team offenses and two team defenses). User interface 330 includes a roster section 332 (located under a “My Team” tab) that informs the team manager 12 of the team units that are on their roster (including associated team statistics). More specifically, roster section 332 shows two team offenses (Packers team offense and Bengals team offense) and two team defenses (Falcons team defense and Ravens team defense) of the team manager 12. Additionally, an edit roster icon 333 is depicted presenting a user-engageable icon that, when engaged, will bring up a subsequent user interface (user interface 340 of FIG. 3E) where team manager 12 can edit their roster.

FIG. 3E illustrates an example screenshot of a user interface 340 informing a team manager 12 of the team manager's 12 roster and available teams to add to a roster. User interface 340 includes a roster section 342 (located under a “My Team” tab) that informs the team manager 12 of the team units that are on their roster (including associated team statistics). More specifically, roster section 342 shows two team offenses (Packers team offense and Bengals team offense) of the team manager 12. User interface 340 further includes an availability section 344 that informs the team manager 12 of the team units that are available to acquire, or “steal” (available to submit a steal request notification to the team managers 12 that own the team units). The team units that are available to steal also include associated team statistics. More specifically, availability section 344 shows three team offenses (Bills team offense, Cowboys team offense, and Dolphins team offense) of other team managers 12 that may be stolen.

FIG. 3F illustrates an example screenshot of a user interface 350 informing a team manager 12 of available teams to add to a roster. User interface 350 includes an availability section 352 (located under a “My Team” tab) that informs the team manager 12 of the team units that are available to “steal” (available to submit a steal request notification to the team managers 12 that own the team units) and also include associated team statistics. More specifically, availability section 352 shows three team offenses (Cowboys team offense, Dolphins team offense, and Buccaneers team offense) of other team managers 12. Within availability section 352, an actuated team section 353 is engaged by the user for the purposes of choosing the Buccaneers team offense as the team that a team manager 12 would like to steal from another team manager 12. Actuated team section 353 includes a team alteration section 354 that provides a team manager 12 the ability to remove teams from the team manager's 12 current roster and place bids on the team unit engaged within actuated team section 353. Team alteration section 354 includes a team removal icon 355 presenting a user-engageable icon that, when engaged, will allow team manager 12 to enter a team unit that team manager 12 would like to remove or drop from their own roster in order to make room on the roster for a new or “stolen” team (as shown, the Bengals team offense). Team alteration section 354 further includes a team bid icon 357 presenting a user-engageable icon that, when engaged, will allow team manager 12 to enter a digital currency bid amount that team manager 12 could be willing to pay for the team unit that team manager 12 chose/engaged within actuated team section 353 (as shown, $15). Team alteration section 354 further includes a bid submission icon 359 presenting a user-engageable icon that, when engaged, will allow team manager 12 to submit the digital currency bid amount entered into team bid icon 357 relative to the team unit that team manager 12 chose/engaged within actuated team section 353. Additionally, engaging bid submission icon 359 may subsequently instruct roster procurement engine 26 to add the Bengals team offense to availability section 344 of FIG. 3E. Engaging bid submission icon 359 may also subsequently instruct notification module 24 to send a steal request notification 362 (see FIG. 3G) to the team manager 12 that owns the team unit that the other team manager 12 chose/engaged within actuated team section 353 (as shown, the Buccaneers team offense).

FIG. 3G illustrates an example screenshot of a user interface 360 presenting to a team manager 12 a steal request notification 362 sent from another team manager 12. User interface 360 includes a steal request notification 362 (located under a “Transactions” tab), which indicates the team unit intended to be taken or “stolen” by another team manager 12 (as shown, the Lions team offense). Steal request notification 362 includes three icons: a “MATCH BID” icon 363, a “SELL TEAM” icon 365, and a “FILIBUSTER” icon 367 (all engageable icons by team manager 12), which all include values of digital currency obtainable for carrying out each task relative to icons 363, 365, 367 (see description of FIG. 1). It is noted that each icon 363, 365, 367, once engaged, directly correlate with one of the three aforementioned actions capable of being performed by roster procurement engine 26 (as well as the three sets of instructions that a team manager 12 can choose from). Additionally, steal request notification 362 further includes a “Match bid, sell team and filibuster” informational icon 369 presenting a user-engageable icon that, when engaged, will bring up a subsequent user interface (user interface 370 of FIG. 3E) where a team manager 12 is provided a summary/rules relative to the tasks associated with icons 363, 365, 367.

FIG. 3H illustrates an example screenshot of a user interface 370 presenting to a team manager 12 a summary/rules section 372 presented via actuation of “Match bid, sell team and filibuster” informational icon 369 of FIG. 3G. Summary/rules section 372, as shown, provides rules and information relative to the tasks associated with icons 363, 365, 367 (in response to steal request notification 362).

In an embodiment, summary/rules relative to “MATCH BID” icon 363 presented in summary/rules section 372 may include: “Match Bid—As the current manager of a team, you can block a steal attempt by matching the bidding manager's bid to keep a team on your roster. A matched bid will be effective immediately. You will invest the cash required to match the bid, the team's market value will reset to the bid amount, and the bid attempt will fail. The bidding manager will receive a notification and will have an opportunity to increase his or her bid.”

In an embodiment, summary/rules relative to “SELL TEAM” icon 365 presented in summary/rules section 372 may include: “Sell Team-When you sell a team, you will immediately profit from the increased value of a team on your roster. You will receive cash for that team equal to the new manager's bid, the team's market value will increase to the bid amount, and the team will be transferred to the bidding manager's roster.”

In an embodiment, summary/rules relative to “FILIBUSTER” icon 367 presented in summary/rules section 372 may include: “Filibuster-Filibustering allows you to hold onto a team until that teams processing window. When clicked, this will signal to the bidding manager that you are unwilling to match their bid, but if they want you to immediately sell the team, they will need to increase their bid. When you click filibuster, the bidding manager will receive a notification that you plan to wait them out. If the bidding manager does not respond with a higher bid or cancel their current bid, the bid will transact during the applicable processing window. If the transaction reaches the processing window, you will receive the bidding manager's bid amount in cash, the team will be transferred to the bidding manager's roster, and the team's market value will then increase to the new manager's bid amount. Filibusters are most effective the day before the team plays that week as it will delay the transaction until the following Monday night processing window.”

It is understood that each team unit facing/facing off against another team unit is configured as a competition to see which team scores more points, where the scoring of points is based on preset rules stored in sports management server 10. In an exemplary embodiment, for a team offense, points scored in a given week in relation to sports management server 10 may correlate to a number of points scored by a sports team's offense in an actual football game in the given week. For a team defense, points scored in a given week in relation to sports management server 10 may correlate to a number of points scored by a sports team's offense in an actual football game against the team defense in the given week, subtracted from 50 initial points.

In an embodiment, when sports management server 10 is utilized in relation to a fantasy football league, each team manager 12 of league 14 competes head-to head with one other team manager 12 of league 14. During the competition, sports management server 10 may track each team manager's 12 record, total points scored, and total points scored against them throughout a season (the weeks/format of which may correspond with an actual professional football season that includes at least a regular season). The top four team managers 12 from the regular season of the competition are chosen to compete in the playoffs that may correspond with the last few weeks of the actual professional football season. As an example, during the first week of playoffs, the first ranked team manager 12 may play against the fourth ranked team manager 12 while the second and third ranked team managers 12 may compete against one another. The winners of these two matchups may play against each other for the championship in a subsequent week while the losers may play against each other for third place.

In regard to digital currency, in an embodiment, each team manager 12 may be granted $100 of digital currency (prior to a fantasy sports draft) for use in relation to a league 14. In an additional embodiment, when fantasy sports management server 10 is utilized in relation to a fantasy football league, a team manager 12 may acquire or add an unrostered team unit for $1 of digital currency.

In embodiments, for a team manager 12 that receives a steal request notification 362, the team manager 12 is requested to respond to the steal request notification 362 within 24 hours. If the steal request notification 362 is not responded to within 24 hours, a transfer of the team is carried out after the 24 hours at the original bid price for the team that is the subject of the steal request notification 362 (with the team manager 12 who received the steal request notification 362 receiving the original bid price and the team manager 12 who sent the steal request notification 362 receiving the team).

It is noted that, in embodiments and in relation to a filibuster in a fantasy football league, Filibusters may be the most effective the day before a team representing a team unit plays in a given week because it delays the transaction until the following Monday night processing window.” This may be advantageous to the team manager 12 performing the filibuster because it keeps the team manager 12 who had initiated the sending of the steal request notification 362 from using one of his team units in a matchup for the given week (the team unit that is dropped/entered into team removal icon 355).

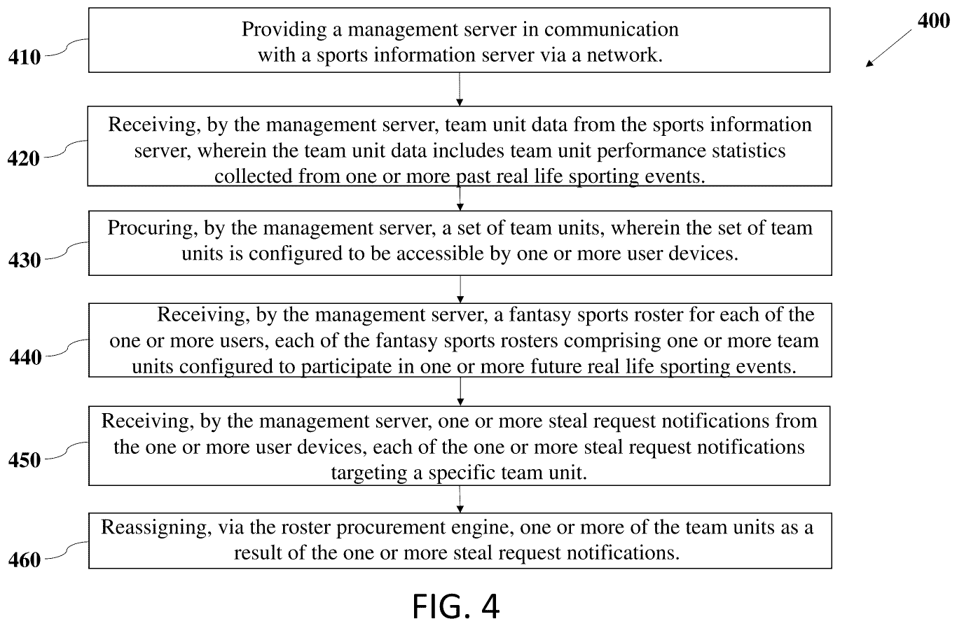

FIG. 4 is an illustration of a flow diagram of an exemplary computerized method 400 for procuring fantasy sports teams for one or more users competing in a fantasy sports league, in accordance with certain example embodiments. In an embodiment, at least a portion of method 400 may be performed by one or more components of fantasy sports management system 15 of FIG. 1 and/or by one or more components of computing machine 100 of FIG. 2. For example, method 400 may be performed by executing particular computer-executable instructions stored on fantasy sports management server 10. Indeed, method 400 may operate in conjunction with fantasy sports management system 15 illustrated in FIG. 1, computing machine 100 of FIG. 2, and/or any one or more portions of any one or more of the other methods/systems described herein. It is noted that fantasy sports management system 15 may include fantasy sports management server 10 communicatively coupled to one or more team manager computing devices 12 and a sports information server 28 via network 15. It is further noted that the term “server” (as presented below) may refer to either of fantasy sports management server 10 or computing machine 100.

Method 400 may include providing a fantasy sports management server 10 in communication with a sports information server 28 via a network 16 (Block 410). Fantasy sports management server 10 receives team unit data from sports information server 28, where the team unit data includes team unit performance statistics collected from one or more past real life sporting events (Block 420). Once the team unit data is received, fantasy sports management server 10 provides a set of team units, where the set of team units is configured to be accessible by one or more team manager user devices 12 (Block 430). The fantasy sports management server 10 receives a fantasy sports roster for each of the one or more team managers, where each of the fantasy sports rosters comprise one or more team units configured to participate in one or more future real life sporting events (Block 440). Fantasy sports management server 10 receives one or more steal request notifications from the one or more team manager user devices 12, where each of the one or more steal request notifications target a specific team unit (Block 450). Roster procurement engine 26 reassigns one or more of the team units as a result of the one or more steal request notifications (Block 460).

In an embodiment, the fantasy sports league is a fantasy football fantasy sports league. In an additional embodiment, each of the set of team units comprise one of: a team offensive unit, a team defensive unit, or a team special teams unit. In other embodiments, the fantasy sports league is a fantasy sports league for a sport other than football (such as, but not limited to: baseball, basketball, hockey, soccer, lacrosse, etc.)

In an embodiment, method 400 further comprises: assigning, by the roster procurement engine, a virtual valuation to at least some of the team units as a result of a draft performed by the one or more users. In a further embodiment, the draft is an auction draft performed by the one or more users.

In an embodiment, method 400 further comprises: sending the one or more steal request notifications to respective user devices of the one or more user devices, where each of the one or more steal request notifications include a request to perform at least one of: sell one of the one or more team units at a first bid amount, block a steal attempt by matching a bid of a respective user of the one or more users that sent a respective one of the one or more steal request notifications, and elect to filibuster.

In a further embodiment, as a result of the electing of the filibuster, method 400 further comprises: reassigning the one or more of the team units after a window of time has passed from an initial sending of a respective one of the one or more steal request notifications. In a further embodiment, as a result of the electing of the filibuster, method 400 further comprises: reassigning the one or more of the team units as a result of a respective one of the one or more users sending a second bid amount to a respective one of the one or more user devices, where the second bid amount is greater than the first bid amount.

In embodiments, a fantasy sports competition carried out using sports management server 10 may utilize data from teams or individuals participating in any actual sport being played.

For the purposes of this disclosure, the terms “management server”, “sports management server”, and “fantasy sports management server” may be synonymous.

For the purpose of this disclosure, the terms “user” and “team manager” may be synonymous.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:
Clause 1, a system for procuring fantasy sports teams for one or more users competing in a fantasy sports league, comprising: a sports information server; a management server in communication with the sports information server via a network, the management server including: a roster procurement engine; one or more processors; and one or more memories, the one or more memories storing instructions thereon that, when executed by the one or more processors, cause the system to: receive team unit data from the sports information server, wherein the team unit data includes team unit performance statistics collected from one or more past real life sporting events; provide a set of team units, wherein the set of team units is configured to be accessible by one or more user devices; receive a fantasy sports roster for each of the one or more users, each of the fantasy sports rosters comprising one or more team units configured to participate in one or more future real life sporting events; receive one or more steal request notifications from the one or more user devices, each of the one or more steal request notifications targeting a specific team unit; and reassign one or more of the team units as a result of the one or more steal request notifications.
Clause 2, the system of Clause 1, wherein the fantasy sports league is a fantasy football fantasy sports league.
Clause 3, the system of Clause 2, wherein each of the set of team units comprise one of: a team offensive unit, a team defensive unit, or a team special teams unit.
Clause 4, the system of Clause 1, wherein, the instructions, when executed by the one or more processors, further cause the system to: assign a virtual valuation to at least some of the team units as a result of a draft performed by the one or more users.
Clause 5, the system of Clause 4, wherein the draft is an auction draft performed by the one or more users.
Clause 6, the system of Clause 1, wherein, the instructions, when executed by the one or more processors, further cause the system to: send the one or more steal request notifications to respective user devices of the one or more user devices, wherein each of the one or more steal request notifications include a request to perform at least one of: sell one of the one or more team units at a first bid amount, block a steal attempt by matching a bid of a respective user of the one or more users that sent a respective one of the one or more steal request notifications, and elect to filibuster.
Clause 7, the system of Clause 6, wherein, as a result of the electing of the filibuster, the instructions, when executed by the one or more processors, further cause the system to: reassign the one or more of the team units after a window of time has passed from an initial sending of a respective one of the one or more steal request notifications.
Clause 8, the system of Clause 6, wherein, as a result of the electing of the filibuster, the instructions, when executed by the one or more processors, further cause the system to: reassign the one or more of the team units as a result of a respective one of the one or more users sending a second bid amount to a respective one of the one or more user devices, wherein the second bid amount is greater than the first bid amount.
Clause 9, a computerized method for procuring fantasy sports teams for one or more users competing in a fantasy sports league, comprising: providing a management server in communication with a sports information server via a network; receiving, by the management server, team unit data from the sports information server, wherein the team unit data includes team unit performance statistics collected from one or more past real life sporting events; providing, by the management server, a set of team units, wherein the set of team units is configured to be accessible by one or more user devices; receiving, by the management server, a fantasy sports roster for each of the one or more users, each of the fantasy sports rosters comprising one or more team units configured to participate in one or more future real life sporting events; receiving, by the management server, one or more steal request notifications from the one or more user devices, each of the one or more steal request notifications targeting a specific team unit; and reassigning, via the roster procurement engine, one or more of the team units as a result of the one or more steal request notifications.
Clause 10, the method of Clause 1, wherein the fantasy sports league is a fantasy football fantasy sports league.
Clause 11, the method of Clause 10, wherein each of the set of team units comprise one of: a team offensive unit, a team defensive unit, or a team special teams unit.
Clause 12, the method of Clause 1, further comprising: assigning, by the roster procurement engine, a virtual valuation to at least some of the team units as a result of a draft performed by the one or more users.
Clause 13, the method of Clause 12, wherein the draft is an auction draft performed by the one or more users.
Clause 14, the method of Clause 1, further comprising: sending the one or more steal request notifications to respective user devices of the one or more user devices, wherein each of the one or more steal request notifications include a request to perform at least one of: sell one of the one or more team units at a first bid amount, block a steal attempt by matching a bid of a respective user of the one or more users that sent a respective one of the one or more steal request notifications, and elect to filibuster.
Clause 15, the method of Clause 14, wherein, as a result of the electing of the filibuster, the method further comprises: reassigning the one or more of the team units after a window of time has passed from an initial sending of a respective one of the one or more steal request notifications.
Clause 16, the method of Clause 14, wherein, as a result of the electing of the filibuster, the method further comprises: reassigning the one or more of the team units as a result of a respective one of the one or more users sending a second bid amount to a respective one of the one or more user devices, wherein the second bid amount is greater than the first bid amount.

What is claimed is:

1. A system for procuring fantasy sports teams for one or more users competing in a fantasy sports league, comprising:
a sports information server;
a management server in communication with the sports information server via a network, the management server including:
a roster procurement engine;
one or more processors; and
one or more memories, the one or more memories storing instructions thereon that, when executed by the one or more processors, cause the system to:
receive team unit data from the sports information server, wherein the team unit data includes team unit performance statistics collected from one or more past real life sporting events;
provide a set of team units, wherein the set of team units is configured to be accessible by one or more user devices;
receive a fantasy sports roster for each of the one or more users, each of the fantasy sports rosters comprising one or more team units configured to participate in one or more future real life sporting events;
receive one or more steal request notifications from the one or more user devices, each of the one or more steal request notifications targeting a specific team unit; and
reassign one or more of the team units as a result of the one or more steal request notifications.

2. The system of claim 1, wherein the fantasy sports league is a fantasy football fantasy sports league.

3. The system of claim 2, wherein each of the set of team units comprise one of: a team offensive unit, a team defensive unit, or a team special teams unit.

4. The system of claim 1, wherein, the instructions, when executed by the one or more processors, further cause the system to:
assign a virtual valuation to at least some of the team units as a result of a draft performed by the one or more users.

5. The system of claim 4, wherein the draft is an auction draft performed by the one or more users.

6. The system of claim 1, wherein, the instructions, when executed by the one or more processors, further cause the system to:
send the one or more steal request notifications to respective user devices of the one or more user devices, wherein each of the one or more steal request notifications include a request to perform at least one of: sell one of the one or more team units at a first bid amount, block a steal attempt by matching a bid of a respective user of the one or more users that sent a respective one of the one or more steal request notifications, and elect to filibuster.

7. The system of claim 6, wherein, as a result of the electing of the filibuster, the instructions, when executed by the one or more processors, further cause the system to:
reassign the one or more of the team units after a window of time has passed from an initial sending of a respective one of the one or more steal request notifications.

8. The system of claim 6, wherein, as a result of the electing of the filibuster, the instructions, when executed by the one or more processors, further cause the system to:
reassign the one or more of the team units as a result of a respective one of the one or more users sending a second bid amount to a respective one of the one or more user devices, wherein the second bid amount is greater than the first bid amount.

9. A computerized method for procuring fantasy sports teams for one or more users competing in a fantasy sports league, comprising:
providing a management server in communication with a sports information server via a network;
receiving, by the management server, team unit data from the sports information server, wherein the team unit data includes team unit performance statistics collected from one or more past real life sporting events;
providing, by the management server, a set of team units, wherein the set of team units is configured to be accessible by one or more user devices;
receiving, by the management server, a fantasy sports roster for each of the one or more users, each of the fantasy sports rosters comprising one or more team units configured to participate in one or more future real life sporting events;
receiving, by the management server, one or more steal request notifications from the one or more user devices, each of the one or more steal request notifications targeting a specific team unit; and
reassigning, via the roster procurement engine, one or more of the team units as a result of the one or more steal request notifications.

10. The method of claim 1, wherein the fantasy sports league is a fantasy football fantasy sports league.

11. The method of claim 10, wherein each of the set of team units comprise one of: a team offensive unit, a team defensive unit, or a team special teams unit.

12. The method of claim 1, further comprising:
assigning, by the roster procurement engine, a virtual valuation to at least some of the team units as a result of a draft performed by the one or more users.

13. The method of claim 12, wherein the draft is an auction draft performed by the one or more users.

14. The method of claim 1, further comprising:
sending the one or more steal request notifications to respective user devices of the one or more user devices, wherein each of the one or more steal request notifications include a request to perform at least one of: sell one of the one or more team units at a first bid amount, block a steal attempt by matching a bid of a respective user of the one or more users that sent a respective one of the one or more steal request notifications, and elect to filibuster.

15. The method of claim 14, wherein, as a result of the electing of the filibuster, the method further comprises:
reassigning the one or more of the team units after a window of time has passed from an initial sending of a respective one of the one or more steal request notifications.

16. The method of claim 14, wherein, as a result of the electing of the filibuster, the method further comprises:
reassigning the one or more of the team units as a result of a respective one of the one or more users sending a second bid amount to a respective one of the one or more user devices, wherein the second bid amount is greater than the first bid amount.
